(19) United States
(12) Patent Application Publication
(10) Pub. No.: US 2025/0305560 A1
(43) Pub. Date: Oct. 2, 2025

(54) ECCENTRIC OSCILLATING GEAR DEVICE

(71) Applicant: SUMITOMO HEAVY INDUSTRIES, LTD., Tokyo (JP)

(72) Inventors: Terumasa NAGASAKI, Yokosuka-shi (JP); Kenji SHIROUZU, Yokosuka-shi (JP)

(21) Appl. No.: 19/236,256

(22) Filed: Jun. 12, 2025

Related U.S. Application Data
(63) Continuation of application No. PCT/JP2023/036180, filed on Oct. 4, 2023.

(30) Foreign Application Priority Data
Dec. 16, 2022 (JP) 2022-201001

(51) Int. Cl. F16H 1/32

(52) U.S. Cl. CPC F16H 1/32; F16H 2001/323

(57) ABSTRACT

An eccentric oscillating gear device includes: an eccentric body; a first oscillating gear and a second oscillating gear that are oscillated by the eccentric body; a spacer member that is sandwiched and disposed in an axial direction between the first oscillating gear and the second oscillating gear; and a pin that is inserted into a pin hole provided in each of the first oscillating gear and the second oscillating gear, in which the spacer member is disposed from a region of the pin in a radially outward direction to a region of the pin in a radially inward direction.

### CROSS-REFERENCE TO RELATED APPLICATIONS

This is a bypass continuation of International PCT Application No. PCT/JP2023/036180, filed on Oct. 4, 2023, which claims priority to Japanese Patent Application No. 2022-201001, filed on Dec. 16, 2022, which are incorporated by reference herein in their entirety.

### BACKGROUND

### Technical Field

Certain embodiments of the present invention relate to an eccentric oscillating gear device.

### Description of Related Art

The related art discloses an eccentric oscillating gear device. In such an eccentric oscillating gear device, an eccentric body shaft is supported by a housing, a carrier, or the like via an input bearing, an eccentric body of the eccentric body shaft is mounted on an oscillating gear via an eccentric body bearing, and the oscillating gear meshes with a meshing gear. When the eccentric body shaft is driven, the oscillating gear rotates while being oscillated by the eccentric body, and rotational motion of the oscillating gear is transmitted to the carrier. Foreign matter, such as abrasive powder, is generated from a meshing portion between the oscillating gear and the meshing gear or the like.

### SUMMARY

According to an embodiment of the present invention, there is provided an eccentric oscillating gear device including an eccentric body, a first oscillating gear and a second oscillating gear that are oscillated by the eccentric body, a spacer member that is sandwiched and disposed in an axial direction between the first oscillating gear and the second oscillating gear, and a pin that is inserted into a pin hole provided in each of the first oscillating gear and the second oscillating gear, in which the spacer member is disposed from a region of the pin in a radially outward direction to a region of the pin in a radially inward direction.

According to another embodiment of the present invention, there is provided an eccentric oscillating gear device including an eccentric body shaft that includes an eccentric body, an oscillating gear that is oscillated by the eccentric body, an eccentric body bearing that is disposed between the oscillating gear and the eccentric body, an input bearing that supports the eccentric body shaft, a carrier member that supports an outer ring of the input bearing, and a regulating member that is disposed between the input bearing and the eccentric body bearing and that regulates a movement of the eccentric body bearing in an axial direction, in which the regulating member includes a radial extension portion that faces, in the axial direction, the carrier member positioned in a radially outward direction with respect to the outer ring of the input bearing.

According to still another embodiment of the present invention, there is provided an eccentric oscillating gear device including an eccentric body shaft that includes an eccentric body, an oscillating gear that is oscillated by the eccentric body, an eccentric body bearing that is disposed between the oscillating gear and the eccentric body, an input bearing that supports the eccentric body shaft, a carrier member that supports an outer ring of the input bearing, and a regulating member that is disposed between the input bearing and the eccentric body bearing and that regulates a movement of the eccentric body bearing in an axial direction, in which the regulating member includes a protrusion portion that protrudes toward the carrier member positioned in a radially outward direction with respect to the outer ring of the input bearing or toward the outer ring of the input bearing.

### BRIEF DESCRIPTION OF THE DRAWINGS

FIG. 1 is a sectional view showing an eccentric oscillating gear device according to one embodiment.

FIG. 2 is a sectional view of a surface taken along line II-II shown in FIG. 1.

FIG. 3 is an enlarged sectional view of a region of III shown in FIG. 1.

FIG. 4 is a sectional view showing an eccentric oscillating gear device according to another embodiment.

FIG. 5 is an enlarged sectional view of a region of V shown in FIG. 4.

FIG. 6 is an enlarged sectional view of a main portion of an eccentric oscillating gear device according to still another embodiment.

FIG. 7 is an enlarged sectional view of a main portion of the eccentric oscillating gear device according to still another embodiment.

### DETAILED DESCRIPTION

When the foreign matter enters a bearing or a rolling contact surface thereof, the bearing, the eccentric body shaft, and the like are damaged at an early stage.

It is desirable to provide an eccentric oscillating gear device capable of suppressing entry of foreign matter.

Hereinafter, one or more embodiments will be described with reference to the drawings, and features and technical effects of the embodiments can be understood from the following detailed description and drawings. However, the scope of the present invention is not limited to the embodiments disclosed below. The drawings are provided for the purpose of example only, and the scope of the present invention is not limited to the examples in the drawings. The same or equivalent components, members, and processes shown in each of the drawings will be assigned with the same reference signs, and redundant description will be omitted as appropriate. A dimension of a member in each of the drawings is shown by being enlarged or reduced as appropriate in order to facilitate understanding. Display of each of the drawings will be made with some members that are not important for describing the embodiments omitted. Although terms including ordinal numbers, such as “first” and “second”, are used in order to describe various components, the terms including the ordinal numbers are used only for the purpose of distinguishing one component from other components, and the terms including the ordinal numbers do not limit the components.

### One Embodiment

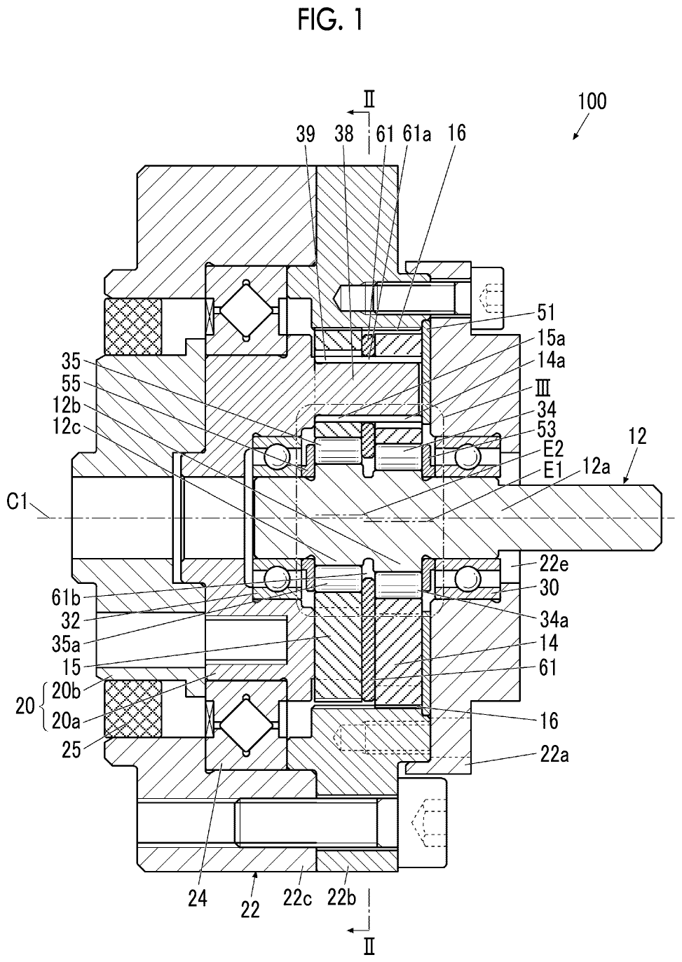

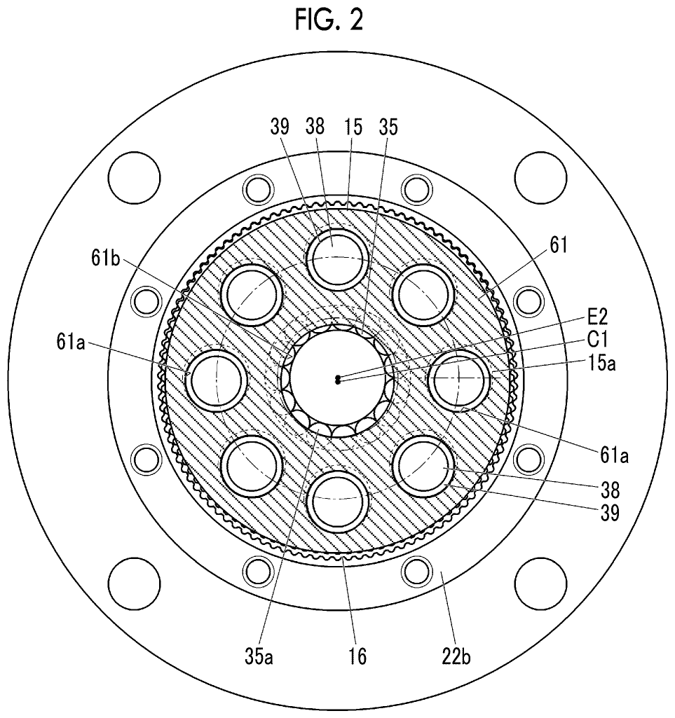

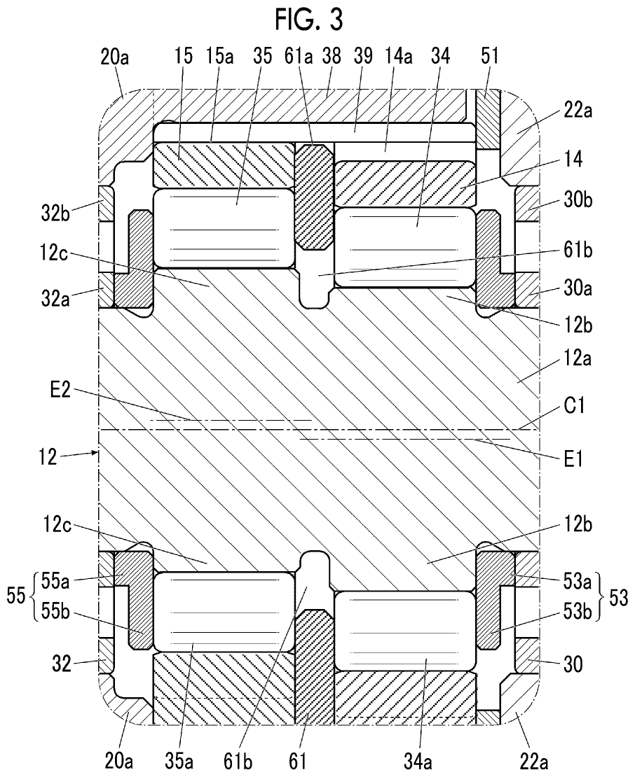

FIG. 1 is a sectional view of an eccentric oscillating gear device 100. FIG. 2 is a sectional view showing a surface taken along line II-II shown in FIG. 1 when viewed in an arrow direction. FIG. 3 is an enlarged view showing a region of III shown in FIG. 1 in an enlarged manner.

An overall configuration of the eccentric oscillating gear device 100 will be described. The eccentric oscillating gear device 100 includes an eccentric body shaft 12, oscillating gears 14 and 15, a meshing gear 16, a carrier 20, a casing 22, a main bearing 24, an oil seal 25, input bearings 30 and 32, eccentric body bearings 34 and 35, an inner pin 38, a spacer 51, regulating members 53 and 55, and a spacer member 61.

The eccentric body shaft 12 (in particular, a shaft main body 12a), the meshing gear 16, and the carrier 20 are coaxial. A direction along a center axis C1 common to the eccentric body shaft 12 (in particular, the shaft main body 12a), the meshing gear 16, and the carrier 20 will be referred to as an “axial direction”. A direction around the center axis C1 with the center axis C1 as a center will be referred to as a “circumferential direction”. A direction perpendicular to the center axis C1 will be referred to as a “radial direction”. A direction toward the center axis C1 along a radius perpendicular to the center axis C1 will be referred to as a “radially inward direction”. A direction separated away from the center axis C1 along the radius perpendicular to the center axis C1 will be referred to as a “radially outward direction”. The center axis C1 extends to the right and left in FIG. 1, and a right side in FIG. 1 is one side in the axial direction, which will be referred to as an “input side”. A left side in FIG. 1 is the other side in the axial direction, which will be referred to as a “counter-input side”. Writing the directions in such a manner is not for limiting a posture in which the eccentric oscillating gear device 100 is used, and the eccentric oscillating gear device 100 can be used in any posture.

The eccentric oscillating gear device 100 is a speed reducer that converts a rotation of the eccentric body shaft 12 into a rotation of the carrier 20 or the casing 22 in a decelerating manner. The eccentric oscillating gear device 100 oscillates the oscillating gears 14 and 15 by rotating the eccentric body shaft 12, thus rotating one of the oscillating gears 14 and 15 and the meshing gear 16, and outputs an axial rotation component thereof from the carrier 20 or the casing 22.

The meshing gear 16 is a gear that meshes with the oscillating gears 14 and 15. One of the oscillating gears 14 and 15 and the meshing gear 16 is an external gear, and the other is an internal gear disposed on an outer peripheral side of the external gear. In the present embodiment, the eccentric oscillating gear device 100 is an external tooth oscillating type eccentric oscillating gear device in which the oscillating gears 14 and 15 are external gears. However, the present invention may be applied to an internal tooth oscillating type eccentric oscillating gear device in which an oscillating gear is an internal gear.

In the present embodiment, the eccentric oscillating gear device 100 is a center crank type eccentric oscillating gear device in which the eccentric body shaft 12 for oscillating the oscillating gears 14 and 15 is disposed at the center of the oscillating gears 14 and 15. However, the eccentric oscillating gear device 100 may be a distribution type eccentric oscillating gear device in which a plurality of eccentric body shafts 12 for oscillating the oscillating gears 14 and 15 are disposed at positions deviated from the center of the oscillating gears 14 and 15.

The casing 22 constitutes an outer shell of the eccentric oscillating gear device 100. The casing 22 includes a hollow portion. The casing 22 includes a first casing member 22a, a second casing member 22b, and a third casing member 22c that are sequentially stacked on the counter-input side. The first casing member 22a and the third casing member 22c are fixed to the second casing member 22b by a plurality of bolts. The first casing member 22a is provided in a plate shape and includes a support hole 22e at a center thereof. The second casing member 22b is provided in a tubular shape and includes a hollow portion at a center thereof. The third casing member 22c is provided in a tubular shape and includes a hollow portion at a center thereof. The support hole 22e of the first casing member 22a, the hollow portion of the second casing member 22b, and the hollow portion of the third casing member 22c communicate with each other.

The carrier 20 is accommodated inside the casing 22 at a part of the casing 22 on the counter-input side and is provided to be relatively rotatable with respect to the casing 22. The carrier 20 includes a first carrier member 20a and a second carrier member 20b sequentially stacked from the input side to the counter-input side. The carrier members 20a and 20b are fixed to each other by bolts. The carrier members 20a and 20b are provided in a cylindrical shape.

A plurality of inner pins 38 are integrated with the carrier 20, particularly the first carrier member 20a. The inner pins 38 are arrayed in the circumferential direction at intervals. The inner pins 38 protrude from the first carrier member 20a to the input side. The inner pins 38 are inserted into rollers 39, respectively, and the rollers 39 rotate around the inner pins 38.

The main bearing 24 is disposed between an inner periphery of the casing 22, more specifically, an inner periphery of the third casing member 22c, and an outer periphery of the carrier 20, more specifically, an outer periphery of the first carrier member 20a. The main bearing 24 rotatably supports the carrier 20 with respect to the casing 22. For example, the main bearing 24 is a rolling bearing such as a roller bearing and a ball bearing, and more specifically, is a cross roller bearing. The main bearing 24 may be another type of bearing.

The oil seal 25 is disposed outside the main bearing 24 (on the counter-input side) in the axial direction between an end of the inner periphery of the casing 22 on the counter-input side, more specifically, the inner periphery of the third casing member 22c and the outer periphery of the carrier 20, more specifically, an outer periphery of the second carrier member 20b.

The input bearings 30 and 32 are placed at an interval therebetween and are sequentially arranged from the input side to the counter-input side. The input bearing 30 is supported inside the casing 22. More specifically, the input bearing 30 is supported by the first casing member 22a in the support hole 22e. The input bearing 30 rotatably supports the eccentric body shaft 12 with respect to the casing 22, more specifically, the first casing member 22a. The input bearing 32 is supported by the inner periphery of the carrier 20, more specifically, the inner periphery of the first carrier member 20a. The input bearing 32 rotatably supports the eccentric body shaft 12 with respect to the carrier 20, more specifically, the first carrier member 20a. The input bearings 30 and 32 are ball bearings, but may be rolling bearings other than the ball bearings. Inner rings 30a and 32a of the input bearing 30 and the input bearing 32 are formed separately from the eccentric body shaft 12. However, the input bearing 30 or the input bearing 32 or both the inner rings 30a and 32a may be formed integrally with the eccentric body shaft 12. An outer ring 30b of the input bearing 30 is formed separately from the first casing member 22a, but may be formed integrally with the first casing member 22a. An outer ring 32b of the input bearing 32 is formed separately from the first carrier member 20a, but may be formed integrally with the first carrier member 20a. In the present embodiment, the input bearing 30 is a shield bearing, whereas the input bearing 32 is not a shield bearing. However, without being limited thereto, the input bearing 30 may not be a shield bearing, and the input bearing 32 may be a shield bearing.

The eccentric body shaft 12 receives rotational power from a driving device (not shown) and is rotated by the rotational power. The driving device is, for example, a prime mover such as a motor, a gear motor, and an engine.

The eccentric body shaft 12 includes the shaft main body 12a and eccentric bodies 12b and 12c.

The shaft main body 12a extends in the axial direction. The shaft main body 12a is connected to the driving device, and rotational power of the driving device is transmitted to the shaft main body 12a. The shaft main body 12a is mounted on the input bearings 30 and 32 and is rotatably supported by the input bearings 30 and 32 coaxially with the carrier 20 and the meshing gear 16. The eccentric body shaft 12 may include a hollow portion penetrating from an end surface of the shaft main body 12a on the input side to an end surface thereof on the counter-input side in the axial direction.

The eccentric bodies 12b and 12c are formed integrally with the shaft main body 12a. The eccentric bodies 12b and 12c are close to each other at an interval therebetween in the axial direction. The first eccentric body 12b includes, on an outer periphery thereof, a columnar surface of which a center axis is an eccentric axis E1 eccentric from the center axis C1. The second eccentric body 12c includes, on an outer periphery thereof, a columnar surface of which a center axis is an eccentric axis E2 eccentric from the center axis C1. The eccentric axis E1 is disposed on a side opposite to the eccentric axis E2 with respect to the center axis C1, and a phase in an eccentric direction from the center axis C1 to the eccentric axis E1 is deviated by 180° from a phase in an eccentric direction from the center axis C1 to the eccentric axis E2. The phase refers to a rotation angle around the center axis C1. The eccentric direction from the center axis C1 to the eccentric axis E1 is a maximum eccentric direction of the first eccentric body 12b, and the eccentric direction from the center axis C1 to the eccentric axis E2 is a maximum eccentric direction of the second eccentric body 12c.

The first oscillating gear 14 includes a circular hole at a center thereof, and the first eccentric body 12b is inserted into the circular hole of the first oscillating gear 14 via the first eccentric body bearing 34, and the first oscillating gear 14 is rotatably supported by the first eccentric body 12b via the first eccentric body bearing 34. The first oscillating gear 14 is coaxial with the first eccentric body 12b, and a rotation axis of the first oscillating gear 14 is eccentric from the center axis C1. Similar to the first oscillating gear 14, the second oscillating gear 15 is rotatably supported by the second eccentric body 12c via the second eccentric body bearing 35.

The first eccentric body bearing 34 includes a plurality of rolling elements 34a. The rolling elements 34a are arrayed in a circumferential direction of the outer periphery of the first eccentric body 12b between the inner periphery of the circular hole of the first oscillating gear 14 and the outer periphery of the first eccentric body 12b. For this reason, the outer periphery of the first eccentric body 12b is an inner ring of the first eccentric body bearing 34, and the inner periphery of the first oscillating gear 14 is an outer ring of the first eccentric body bearing 34. The rolling elements 34a roll on the outer periphery of the first eccentric body 12b and the inner periphery of the first oscillating gear 14. The rolling elements 34a are rollers. The rolling elements 34a made of the rollers contribute to improvement in a load capacity of the first eccentric body bearing 34 compared to a rolling element made of a sphere. Similar to the first eccentric body bearing 34, the second eccentric body bearing 35 also includes a plurality of rolling elements 35a arrayed in a circumferential direction of the outer periphery of the second eccentric body 12c between the inner periphery of the circular hole of the second oscillating gear 15 and the outer periphery of the second eccentric body 12c. The first eccentric body bearing 34 and the second eccentric body bearing 35 may include an outer ring separate from the first oscillating gear 14 and the second oscillating gear 15 or an inner ring separate from the first eccentric body 12b and the second eccentric body 12c.

The first oscillating gear 14 includes a plurality of pin holes 14a around the circular hole at the center. The pin holes 14a penetrate the first oscillating gear 14 in the axial direction. The pin holes 14a are arrayed at intervals in a circumferential direction around the rotation axis of the first oscillating gear 14. A set of the inner pin 38 and the roller 39 is inserted into each of the pin holes 14a. Outer diameters of the inner pin 38 and the roller 39 are smaller than an inner diameter of the pin hole 14a, and an outer periphery of the roller 39 is partially in contact with an inner periphery of the pin hole 14a. Similar to the first oscillating gear 14, the second oscillating gear 15 also includes a plurality of pin holes 15a, and the set of the inner pin 38 and the roller 39 is inserted into each of the pin holes 15a.

The roller 39 may not be provided, the inner pins 38 may be inserted into the pin holes 14a and 15a, and outer peripheries of the inner pins 38 may partially come into contact with the inner peripheries of the pin holes 14a and 15a. In this case, the outer diameters of the inner pins 38 are equal to the outer diameters of the rollers 39.

The first oscillating gear 14 includes a plurality of external teeth formed on an outer periphery thereof. Meanwhile the meshing gear 16 is formed on the inner periphery of the casing 22, specifically, on the inner periphery of the second casing member 22b, the meshing gear 16 includes a plurality of internal teeth, and the first oscillating gear 14 meshes with the meshing gear 16. Similar to the first oscillating gear 14, the second oscillating gear 15 includes the same number of external teeth as the number of teeth of the first oscillating gear 14 on the outer periphery thereof, and the second oscillating gear 15 meshes with the meshing gear 16. The internal teeth of the meshing gear 16 may be integrally formed on the inner periphery of the second casing member 22b or may be configured by a pin member that is rotatably disposed in a pin groove provided in the inner periphery of the second casing member 22b. In meshing portions between the oscillating gears 14 and 15 and the meshing gear 16, abrasive powder is likely to be generated from the gears.

The number of teeth of the first oscillating gear 14 and the second oscillating gear 15 is smaller than the number of teeth of the meshing gear 16. For example, the number of teeth of the first oscillating gear 14 and the second oscillating gear 15 is smaller than the number of teeth of the meshing gear 16 by one or two. When the eccentric body shaft 12 rotates, the oscillating gears 14 and 15 rotate while oscillating. Therefore, a meshing position between the first oscillating gear 14 and the meshing gear 16 moves in the circumferential direction, and a meshing position between the second oscillating gear 15 and the meshing gear 16 moves in the circumferential direction in a state of being deviated from the meshing position between the first oscillating gear 14 and the meshing gear 16 by 180° in phase.

When the oscillating gears 14 and 15 rotate while oscillating due to the rotation of the eccentric body shaft 12, the inner pin 38 revolves around the center axis C1, and rotational motion components of the oscillating gears 14 and 15 are transmitted to the carrier 20 by the inner pin 38. Accordingly, a decelerated rotation is extracted from the carrier 20. Since the outer diameter of the roller 39 is smaller than the inner diameters of the pin holes 14a and 15a, oscillating motion components of the oscillating gears 14 and 15 are not transmitted to the carrier 20. In a case where the carrier 20 is fixed to an external member, a revolution of the inner pin 38 and the rotations of the first oscillating gear 14 and the second oscillating gear 15 are constrained, and a decelerated rotation is extracted from the meshing gear 16 and the casing 22. That is, the inner pin 38 can be a member that is synchronized with axial rotation components of the first oscillating gear 14 and the second oscillating gear 15.

The spacer 51 is fixed to an inner surface of the hollow portion of the casing 22 on the input side in the hollow portion. Specifically, the spacer 51 is formed in a ring shape, and an outer periphery of the spacer 51 is sandwiched between the first casing member 22a and the second casing member 22b. The spacer 51 is sandwiched between the first casing member 22a and the first oscillating gear 14 in the axial direction, and a gap between the first casing member 22a and the first oscillating gear 14 is filled with the spacer 51. In addition, the spacer 51 is in contact with an axial end surface of the roller 39. The spacer 51 is made of a material having hardness higher than hardness of the first casing member 22a and prevents the first casing member 22a from being worn by sliding with the first oscillating gear 14 or the roller 39.

The spacer 51 surrounds the shaft main body 12a of the eccentric body shaft 12 in the circumferential direction and is separated away from the outer periphery of the shaft main body 12a of the eccentric body shaft 12 in the radially outward direction. A regulating member 53 is disposed between an inner periphery of the spacer 51 and the outer periphery of the shaft main body 12a.

The regulating member 53 is a separate body from the eccentric body shaft 12 and is provided in a ring shape to surround the shaft main body 12a of the eccentric body shaft 12 in the circumferential direction. The regulating member 53 is sandwiched between the first eccentric body 12b and the inner ring 30a of the input bearing 30 in the axial direction, and a movement of the regulating member 53 in the axial direction is regulated by the first eccentric body 12b and the input bearing 30. The regulating member 53 comes into contact with end surfaces of the plurality of rolling elements 34a on the input side, and the rolling elements 34a are prevented from coming out (moving in the axial direction) from the circular hole of the first oscillating gear 14 by the regulating member 53. The regulating member 53 includes a tubular portion 53a that is fitted to the shaft main body 12a of the eccentric body shaft 12 and a radial extension portion 53b that protrudes in the radially outward direction from an end of the tubular portion 53a on the counter-input side. The tubular portion 53a protrudes from an inner peripheral portion of the radial extension portion 53b on the input side and is sandwiched between the first eccentric body 12b and the inner ring 30a of the input bearing 30 in the axial direction. The radial extension portion 53b is separated away from the input bearing 30 and comes into contact with the rolling elements 34a. The radial extension portion 53b will also be referred to as a flange.

A regulating member 55 is disposed at a location separated to the counter-input side away from the regulating member 53. The regulating member 55 is a separate body from the eccentric body shaft 12 and is provided in a ring shape to surround the shaft main body 12a of the eccentric body shaft 12 in the circumferential direction. The regulating member 55 is sandwiched between the second eccentric body 12c and the inner ring 32a of the input bearing 32 in the axial direction, and a movement of the regulating member 55 in the axial direction is regulated by the second eccentric body 12c and the input bearing 32. The regulating member 55 comes into contact with end surfaces of the plurality of rolling elements 35a on the counter-input side, and the rolling elements 35a are prevented from coming out (moving in the axial direction) from the circular hole of the second oscillating gear 15 by the regulating member 55. The regulating member 55 includes a tubular portion 55a that is fitted to the shaft main body 12a of the eccentric body shaft 12 and a radial extension portion 55b that protrudes in the radially outward direction from an end of the tubular portion 55a on the input side. The tubular portion 55a protrudes from an inner peripheral portion of the radial extension portion 55b on the counter-input side and is sandwiched between the second eccentric body 12c and the inner ring 32a of the input bearing 32 in the axial direction. The radial extension portion 55b is separated away from the input bearing 32 and comes into contact with the rolling elements 35a.

The spacer member 61 is disposed between the regulating member 53 and the regulating member 55. The spacer member 61 is a separate body from the eccentric body shaft 12. The spacer member 61 is an annular plate member provided to surround the shaft main body 12a of the eccentric body shaft 12 in the circumferential direction. For this reason, the spacer member 61 includes a through-hole 61b through which the shaft main body 12a of the eccentric body shaft 12 passes at a center. The spacer member 61 is sandwiched between the first oscillating gear 14 and the second oscillating gear 15 in the axial direction, and a gap between the first oscillating gear 14 and the second oscillating gear 15 is filled with the spacer member 61. In the present specification, being sandwiched between a member (first oscillating gear 14) and a member (second oscillating gear 15) in the axial direction means not only a case of being in contact with and being sandwiched between the same members (the first oscillating gear 14 and the second oscillating gear 15) but also a case of being sandwiched via another spacer member or the like.

The spacer member 61 includes a plurality of insertion holes 61a, and the insertion holes 61a penetrate the spacer member 61 in the axial direction. The insertion holes 61a are arrayed at intervals in a circumferential direction around the rotation axes of the oscillating gears 14 and 15. Since the set of the inner pin 38 and the roller 39 is fitted into each of the insertion holes 61a, the spacer member 61 is disposed from a region of the inner pin 38 in the radially outward direction to a region of the inner pin 38 in the radially inward direction. The spacer member 61 rotates together with the oscillating gears 14 and 15 due to the revolution of the inner pin 38, but does not oscillate.

The inner diameter of the through-hole 61b of the spacer member 61 is smaller than the inner diameters of the circular holes of the oscillating gears 14 and 15 at the centers, and the spacer member 61 overhangs in the radially inward direction from edges of the circular holes of the oscillating gears 14 and 15 at the centers. A portion of the spacer member 61 that overhangs in the radially inward direction from the edges of the circular holes of the oscillating gears 14 and 15 at the centers is sandwiched and disposed in the axial direction between the rolling element 34a of the first eccentric body bearing 34 and the rolling element 35a of the second eccentric body bearing 35.

As described above, the spacer member 61 is disposed from the region of the inner pin 38 in the radially outward direction to the region of the inner pin 38 in the radially inward direction. Therefore, it is difficult for foreign matter, such as abrasive powder generated at the oscillating gears 14 and 15 in the radially outward direction, to enter the oscillating gears 14 and 15 in the radially inward direction through a gap between the oscillating gears 14 and 15. In particular, an inner peripheral portion of the spacer member 61 is sandwiched between the rolling element 34a of the first eccentric body bearing 34 and the rolling element 35a of the second eccentric body bearing 35 in the axial direction. Therefore, it is difficult for the foreign matter to enter gaps around the rolling elements 34a and 35a of the eccentric body bearings 34 and 35. This contributes to suppressing damage to the eccentric body bearings 34 and 35 and the eccentric bodies 12b and 12c and contributes to extending the lives of the eccentric body bearings 34 and 35 and the eccentric oscillating gear device 100.

### Another Embodiment

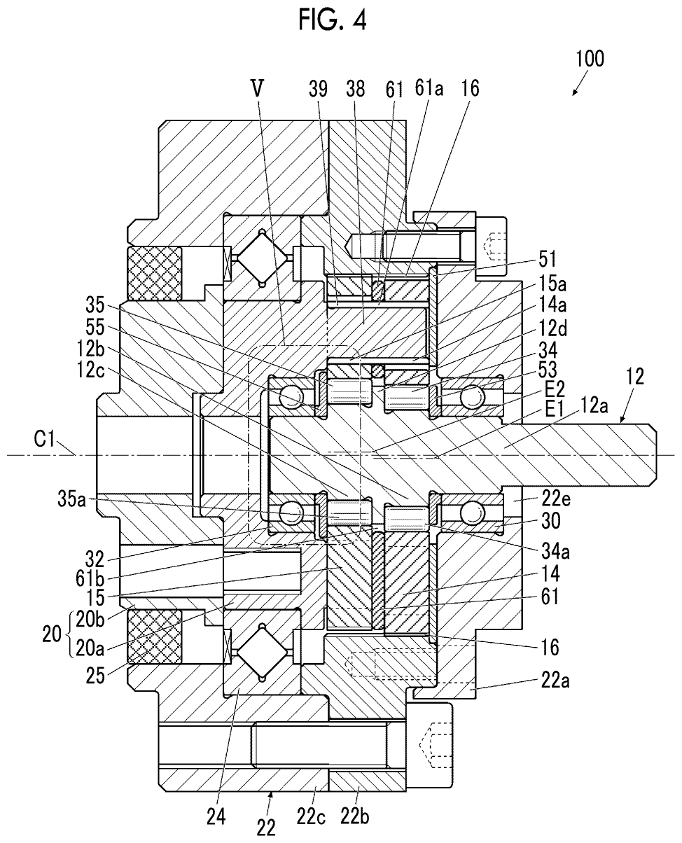

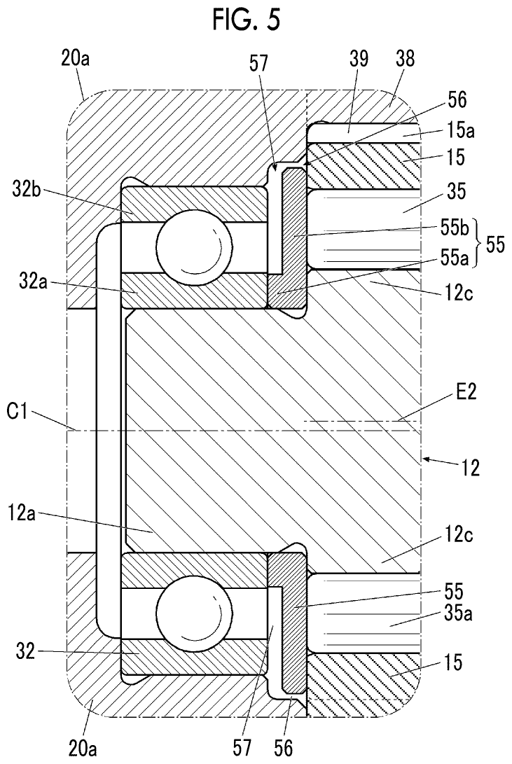

Another embodiment will be described with reference to FIGS. 4 and 5. FIG. 4 is a sectional view of the eccentric oscillating gear device 100 according to another embodiment. FIG. 5 is an enlarged view showing a region of V shown in FIG. 4 in an enlarged manner. Another embodiment is changed from one embodiment in the following points, and another embodiment is the same as one embodiment except for the following description.

The outer diameter of the radial extension portion 55b of the regulating member 55 of another embodiment is larger than the outer diameter of the radial extension portion 55b of the regulating member 55 of one embodiment. That is, in one embodiment, the outer periphery of the radial extension portion 55b is disposed in the radially inward direction with respect to the outer periphery of the outer ring 32b of the input bearing 32, whereas in another embodiment, the outer periphery of the radial extension portion 55b is disposed in the radially outward direction with respect to the outer periphery of the outer ring 32b of the input bearing 32, and the radial extension portion 55b overhangs in the radially outward direction from the outer periphery of the outer ring 32b of the input bearing 32.

For this reason, in another embodiment, the radial extension portion 55b faces, in the axial direction, the first carrier member 20a positioned in the radially outward direction with respect to the outer ring 32b of the input bearing 32. In addition, the radial extension portion 55b extends in the radially outward direction from the second eccentric body bearing 35 in the maximum eccentric direction of the eccentric body 12b.

The outer periphery of the radial extension portion 55b is slightly separated away from the inner periphery of the first carrier member 20a in the radially inward direction, and a slight gap 56 is present therebetween. The gap 56 will also be referred to as a radial gap. In addition, the radial extension portion 55b is separated away in the axial direction from a portion of the first carrier member 20a, which faces the radial extension portion 55b in the axial direction, and a gap 57 is present therebetween. The gap 57 will also be referred to as an axial gap. The gaps 56 and 57 do not generate a frictional resistance between the radial extension portion 55b and the first carrier member 20a. An interval of the gap 56 in the radial direction is smaller than an interval of the gap 57 in the axial direction. The radial extension portion 55b is separated away from the outer ring 32b of the input bearing 32 in the axial direction, and a frictional resistance is not generated between the radial extension portion 55b and the input bearing 32.

As described above, the radial extension portion 55b overhangs in the radially outward direction from the outer periphery of the outer ring 32b of the input bearing 32, and the overhanging portion faces, in the axial direction, the first carrier member 20a positioned in the radially outward direction with respect to the outer ring 32b of the input bearing 32. Therefore, the gap 56 is small. For this reason, it is difficult for foreign matter, such as abrasive powder, to move from the second oscillating gear 15 to the input bearing 32 through the gap 56, and the foreign matter is prevented from entering the input bearing 32.

Since the radial extension portion 55b extends more than the rolling element 35a of the second eccentric body bearing 35 in the radially outward direction, foreign matter is prevented from entering the circular hole of the second oscillating gear 15 at the center.

The inner diameter of the spacer member 61 of another embodiment is larger than the inner diameter of the spacer member 61 of one embodiment, and the spacer member 61 does not overhang in the radially inward direction from the edges of the circular holes of the oscillating gears 14 and 15 at the centers. Instead, a flange 12d is formed on the outer periphery of the shaft main body 12a of the eccentric body shaft 12 between the eccentric bodies 12b and 12c, and the flange 12d overhangs in the radially outward direction from the outer peripheries of the eccentric bodies 12b and 12c. The flange 12d is sandwiched between the rolling element 34a of the first eccentric body bearing 34 and the rolling element 35a of the second eccentric body bearing 35 in the axial direction. As in one embodiment, also in another embodiment, the flange 12d may not be provided, and the spacer member 61 may overhang in the radially inward direction from the edges of the circular holes of the oscillating gears 14 and 15 at the centers, and the overhanging portion may be sandwiched between the rolling element 34a of the first eccentric body bearing 34 and the rolling element 35a of the second eccentric body bearing 35 in the axial direction.

As in the case of one embodiment, also in another embodiment, the radial extension portion 53b of one regulating member 53 does not overhang in the radially outward direction from the outer periphery of the outer ring 30b of the input bearing 30. On the other hand, the radial extension portion 53b may overhang in the radially outward direction from the outer periphery of the outer ring 30b of the input bearing 30 and may face the first casing member 22a in the axial direction and the radial direction. In this case, since foreign matter is prevented from entering the input bearing 30, the input bearing 30 may be a bearing that is not shielded. When the input bearing 30 is not shielded, the size of the input bearing 30 in the axial direction is small. Therefore, the size of the first casing member 22a in the axial direction can also be small, and the entire device can be made small in the axial direction.

### Still Another Embodiment

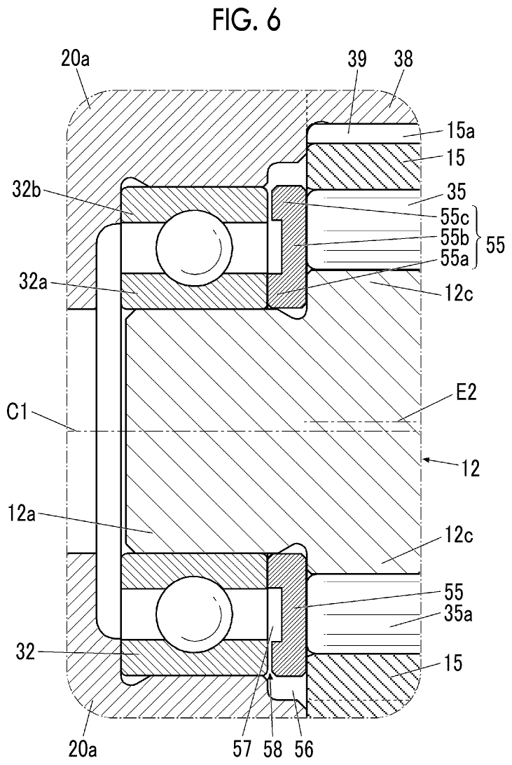

Still another embodiment will be described with reference to FIG. 6. FIG. 6 is a sectional view of a part of an eccentric oscillating gear device in still another embodiment. A region shown in FIG. 6 corresponds to the region V shown in FIG. 5 in another embodiment. Still another embodiment is changed from one embodiment in the following points, and still another embodiment is the same as one embodiment except for the following description.

In still another embodiment, the regulating member 55 further includes a protrusion portion 55c in addition to the tubular portion 55a and the radial extension portion 55b. The protrusion portion 55c is provided in a ring shape along the outer periphery of the radial extension portion 55b and protrudes in the axial direction from the radial extension portion 55b toward the outer ring 32b of the input bearing 32. The protrusion portion 55c faces the outer ring 32b of the input bearing 32 in the axial direction in a state of being separated away from the outer ring 32b of the input bearing 32 in the axial direction. For this reason, a gap 58 is present between the protrusion portion 55c and the outer ring 32b of the input bearing 32. The gap 58 will also be referred to as an axial gap.

Since such a protrusion portion 55c is provided, it is difficult for foreign matter, such as abrasive powder, to move to the input bearing 32 from the regulating member 55 in the radially outward direction through the gap 58, and the foreign matter is prevented from entering the input bearing 32.

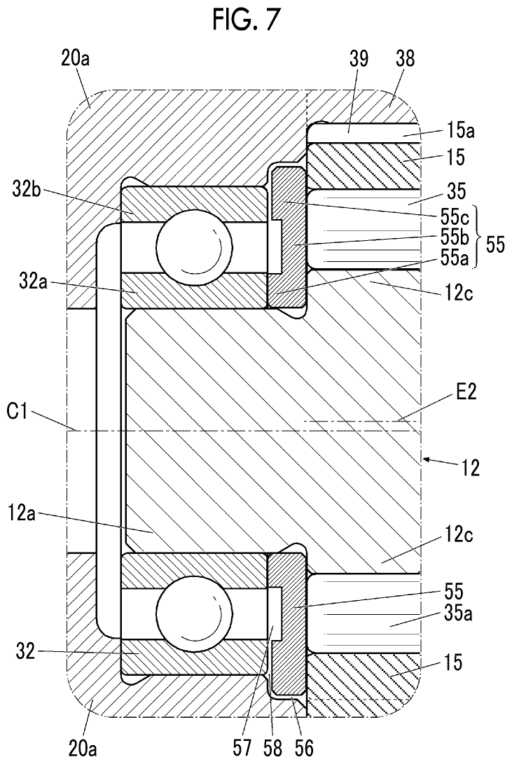

In the example shown in FIG. 6, the outer diameter of the outer periphery of the protrusion portion 55c is smaller than the outer diameter of the outer periphery of the outer ring 32b of the input bearing 32, and the outer periphery of the protrusion portion 55c is disposed in the radially inward direction with respect to the outer periphery of the outer ring 32b of the input bearing 32. On the other hand, as shown in FIG. 7, the outer diameter of the outer periphery of the protrusion portion 55c may be larger than the outer diameter of the outer periphery of the outer ring 32b of the input bearing 32, and the protrusion portion 55c may overhang in the radially outward direction from the outer periphery of the outer ring 32b of the input bearing 32. In this case, the protrusion portion 55c faces the outer ring 32b of the input bearing 32 in the axial direction. In the radially outward direction with respect to the outer periphery of the outer ring 32b of the input bearing 32, the protrusion portion 55c faces, in the axial direction, the first carrier member 20a positioned in the radially outward direction with respect to the outer ring 32b of the input bearing 32. In addition, in this case, as in the case of another embodiment, the radial extension portion 55b overhangs in the radially outward direction from the outer periphery of the outer ring 32b of the input bearing 32.

As in another embodiment, also in still another embodiment, the spacer member 61 does not overhang in the radially inward direction from the edges of the circular holes of the oscillating gears 14 and 15 at the centers, and the flange 12d is formed on the outer periphery of the shaft main body 12a of the eccentric body shaft 12 between the eccentric bodies 12b and 12c. It is evident that, as in one embodiment, also in still another embodiment, the flange 12d may not be provided, and the spacer member 61 may overhang in the radially inward direction from the edges of the circular holes of the oscillating gears 14 and 15 at the centers.

As in a case where the regulating member 55 includes the protrusion portion 55c, another regulating member 53 may include a protrusion portion. The protrusion portion is provided in a ring shape along the outer periphery of the radial extension portion 53b and protrudes in the axial direction from the radial extension portion 53b toward the outer ring 30b of the input bearing 30.

### Modification Example

In each of the embodiments, the casing 22 is an assembly of the three casing members 22a to 22c, but the casing 22 may be configured by one member or may be an assembly of four members.

In each of the embodiments, an example in which the number of oscillating gears 14 and 15 is two is shown. However, the number of oscillating gears 14 and 15 may be 1 or 3 or more.

Instead of the first casing member 22a, the second carrier member 20b may be fitted to the input bearing 30, and the second carrier member 20b may be rotatably supported by the input bearing 30 with respect to the shaft main body 12a of the eccentric body shaft 12. In this case, the second carrier member 20b is rotatably supported by the main bearing with respect to the second casing member 22b, the second carrier member 20b is connected to the first carrier member 20a by a carrier pin, and the second carrier member 20b and the first carrier member 20a rotate integrally. Like the inner pin 38, the carrier pin is disposed on a circumference on which the inner pin 38 is arrayed and penetrates the oscillating gears 14 and 15 and the spacer member 61. While the inner pin 38 transmits power of rotational motion of the oscillating gears 14 and 15 to the first carrier member 20a and the second carrier member 20b, the carrier pin does not transmit the power of the rotational motion of the oscillating gears 14 and 15 to the first carrier member 20a and the second carrier member 20b. However, functions of the inner pin 38 and the carrier pin may be integrated with each other, and the inner pin 38 may be capable of both extracting the rotational motion of the oscillating gears 14 and 15 and connecting the first carrier member 20a and the second carrier member 20b to each other.

In each of the embodiments, the inner pin 38 is formed integrally with the first carrier member 20a. However, the inner pin 38 may be formed separately from the first carrier member 20a, and the inner pin 38 may be assembled to the first carrier member 20a.

The outer ring of the main bearing 24 may be formed integrally with the third casing member 22c. The inner ring of the main bearing 24 may be formed integrally with the first carrier member 20a.

It should be understood that the invention is not limited to the above-described embodiment, but may be modified into various forms on the basis of the spirit of the invention. Additionally, the modifications are included in the scope of the invention.

What is claimed is:

1. An eccentric oscillating gear device, comprising:
an eccentric body;
a first oscillating gear and a second oscillating gear that are oscillated by the eccentric body;
a spacer member that is sandwiched and disposed in an axial direction between the first oscillating gear and the second oscillating gear; and
a pin that is inserted into a pin hole provided in each of the first oscillating gear and the second oscillating gear,
wherein the spacer member is disposed from a region of the pin in a radially outward direction to a region of the pin in a radially inward direction.

2. The eccentric oscillating gear device according to claim 1,
wherein a plurality of the pins are arrayed at intervals in a circumferential direction, the spacer member is an annular plate member, a plurality of insertion holes formed in the spacer member are arrayed at intervals in the circumferential direction, and the plurality of pins are inserted into the plurality of insertion holes, respectively.

3. The eccentric oscillating gear device according to claim 1, further comprising:
a first eccentric body bearing that is disposed between the first oscillating gear and the eccentric body; and
a second eccentric body bearing that is disposed between the second oscillating gear and the eccentric body,
wherein the spacer member is sandwiched and disposed in the axial direction between the first eccentric body bearing and the second eccentric body bearing.

4. The eccentric oscillating gear device according to claim 3,
wherein the eccentric body includes a first eccentric body and a second eccentric body, the first oscillating gear includes a circular hole at a center of the first oscillating gear, the first eccentric body is inserted into the circular hole of the first oscillating gear via the first eccentric body bearing, and the first oscillating gear is rotatably supported by the first eccentric body via the first eccentric body bearing.

5. The eccentric oscillating gear device according to claim 4,
wherein the second oscillating gear includes a circular hole at a center of the second oscillating gear, the second eccentric body is inserted into the circular hole of the second oscillating gear via the second eccentric body bearing, and the second oscillating gear is rotatably supported by the second eccentric body via the second eccentric body bearing.

6. The eccentric oscillating gear device according to claim 4,
wherein the first eccentric body and the second eccentric body respectively include eccentric axes that are eccentric from a center axis, and the eccentric axis of the first eccentric body is disposed on a side opposite to the eccentric axis of the second eccentric body with respect to the center axis.

7. The eccentric oscillating gear device according to claim 4,
wherein the first eccentric body bearing includes a plurality of rolling elements arrayed in a circumferential direction of an outer periphery of the first eccentric body between an inner periphery of the circular hole of the first oscillating gear and the outer periphery of the first eccentric body.

8. The eccentric oscillating gear device according to claim 4,
wherein the second eccentric body bearing includes a plurality of rolling elements arrayed in a circumferential direction of an outer periphery of the second eccentric body between an inner periphery of the circular hole of the second oscillating gear and the outer periphery of the second eccentric body.

9. The eccentric oscillating gear device according to claim 1, further comprising a meshing gear that meshes with the first oscillating gear and the second oscillating gear.

10. The eccentric oscillating gear device according to claim 9,
wherein the first oscillating gear and the second oscillating gear respectively include a plurality of external teeth formed on outer peripheries of the first oscillating gear and the second oscillating gear, and the number of teeth of the first oscillating gear and the second oscillating gear is smaller than the number of teeth of the meshing gear.

11. An eccentric oscillating gear device, comprising:
an eccentric body shaft that includes an eccentric body;
an oscillating gear that is oscillated by the eccentric body;
an eccentric body bearing that is disposed between the oscillating gear and the eccentric body;
an input bearing that supports the eccentric body shaft;
a carrier member that supports an outer ring of the input bearing; and
a regulating member that is disposed between the input bearing and the eccentric body bearing and that regulates a movement of the eccentric body bearing in an axial direction,
wherein the regulating member includes a radial extension portion that faces, in the axial direction, the carrier member positioned in a radially outward direction with respect to the outer ring of the input bearing.

12. The eccentric oscillating gear device according to claim 11,
wherein in a maximum eccentric direction of the eccentric body, the regulating member extends in the radially outward direction from the eccentric body bearing.

13. The eccentric oscillating gear device according to claim 11,
wherein a radial gap between the regulating member and the carrier member is smaller than an axial gap between the regulating member and the carrier member.

14. An eccentric oscillating gear device, comprising:
an eccentric body shaft that includes an eccentric body;
an oscillating gear that is oscillated by the eccentric body;
an eccentric body bearing that is disposed between the oscillating gear and the eccentric body;
an input bearing that supports the eccentric body shaft;
a carrier member that supports an outer ring of the input bearing; and
a regulating member that is disposed between the input bearing and the eccentric body bearing and that regulates a movement of the eccentric body bearing in an axial direction,
wherein the regulating member includes a protrusion portion that protrudes toward the carrier member positioned in a radially outward direction with respect to the outer ring of the input bearing or toward the outer ring of the input bearing.

15. The eccentric oscillating gear device according to claim 14,
wherein the protrusion portion faces both the outer ring of the input bearing and the carrier member in the axial direction.
